(19) United States
(12) Patent Application Publication
(10) Pub. No.: US 2022/0250369 A1
(43) Pub. Date: Aug. 11, 2022

(54) BIOHAZARD BARRIER AND SYSTEM FOR A HUMAN HAND

(71) Applicant: Diane Carole Potter, Marshall, VA (US)

(72) Inventor: Diane Carole Potter, Marshall, VA (US)

(21) Appl. No.: 17/172,129

(22) Filed: Feb. 10, 2021

(51) Int. Cl. B32B 27/28; B32B 27/08; B32B 27/30; A41D 19/00

(52) U.S. Cl. CPC B32B 27/283; B32B 27/08; B32B 27/302; B32B 2307/546; A41D 19/0055; B32B 2307/7145; B32B 2571/00; A41D 19/0006

(57) ABSTRACT

A skin barrier system includes an adhesive layer that reasonably secures on the underside of a palmar region and phalanx region of a hand; a biohazard barrier layer attached to the adhesive layer, biohazard barrier layer being configured to come in contact with surfaces and prevents containments from traveling through the biohazard barrier layer and the adhesive layer. An aspect of the disclosure includes a two-sided, molded material for a barrier on the palm side of the hand and fingers. One side adheres to hand and the other side may be configured to contact surfaces while keeping bacteria from getting through to the skin of a human hand.

### CROSS-REFERENCE TO RELATED APPLICATIONS

This application claims the benefit of priority to U.S. Provisional App. No. 62/995,719 filed Feb. 11, 2020, the contents therein are incorporated by reference in its entirety therein.

### FIELD

The present disclosure relates to hygienic supplies and personal protective equipment for the hand, and more particularly, relates to flat skin hand covers/barriers used to come into contact with contaminated surfaces, objects, or individuals.

### BACKGROUND

The current global challenge of COVID-19 pandemic has surpassed the provincial, radical, conceptual, spiritual, social, and pedagogical boundaries. According to the Center of Disease Control, COVID-19 is primarily transmitted from person-to-person through respiratory droplets. These droplets are released when someone with COVID-19 sneezes, coughs, or talks. Infectious droplets can land in the mouths or noses of people who are nearby or possibly be inhaled into the lungs. A physical distance of at least 1 meter (3 ft) between persons is suggested by the World Health Organization (WHO) to avoid infection, although some WHO member states have recommended maintaining greater distances whenever possible. Respiratory droplets can land on hands, objects or surfaces around the person when they cough or talk, and people can then become infected with COVID-19 from touching hands, objects or surfaces with droplets and then touching their eyes, nose, or mouth. Recent data suggest that there can be transmission of COVID-19 through droplets of those with mild symptoms or those who do not feel ill. Short-range inhalation of aerosols is a possibility for COVID-19, as with many respiratory pathogens. However, this cannot easily be distinguished from “droplet” transmission based on epidemiologic patterns. Short-range transmission is a possibility particularly in crowded medical wards and inadequately ventilated spaces. Certain procedures in health facilities can generate fine aerosols and should be avoided whenever possible.

COVID-19 has a mean incubation period of 5.2 days. The infection is acute without any carrier status. Symptoms usually begin with nonspecific syndromes, including fever, dry cough, and fatigue. Multiple systems may be involved, including respiratory (cough, short of breath, sore throat, rhinorrhea, hemoptysis, and chest pain), gastrointestinal (diarrhea, nausea, and vomiting), musculoskeletal (muscle ache), and neurologic (headache or confusion). More common signs and symptoms are fever, cough and short of breath. There were about 15% with fever, cough, and short of breath.

### SUMMARY

In light of the foregoing background, the following presents a simplified summary of the present disclosure to provide a basic understanding of some aspects of the disclosure. This summary is not an extensive overview of the disclosure. It is not intended to identify key or critical elements of the disclosure, or to delineate the scope of the disclosure. The following summary merely presents some concepts of the disclosure in a simplified form as a prelude to the more detailed description provided below.

An aspect of the disclosure includes a skin barrier system comprising an adhesive layer that secures on the underside of a palmar region and phalanx region of a hand; a biohazard barrier layer attached to the adhesive layer, biohazard barrier layer being configured to come in contact with surfaces and prevents containments from traveling through the biohazard barrier layer and the adhesive layer.

An aspect of the disclosure includes, a two-sided, molded material for a barrier on the palm side of the hand and fingers. One side adheres to hand and the other side may be configured to contact surfaces while keeping bacteria from getting through to the skin of a human hand.

An aspect of the disclosure includes, a skin barrier system for a human hand, comprising an adhesive layer that releasably secures to area corresponding to distal phalanges of a human hand; a biohazard barrier layer attached to the adhesive layer, the biohazard barrier layer being configured to come in contact with surfaces and prevents containments from traveling through the biohazard barrier layer, the adhesive layer to a skin of the human hand.

An aspect of the disclosure includes a flat skin hand cover/barrier that has a substantially continuous two flat layered body made up of two different materials acting in sequence with one another. The invention finds utility in public and domestic settings where objects and surfaces are used by multiple individuals.

The biohazard barrier and system may be beneficial in climates where the occurrence of disease and transfer of disease is more prevalent. Furthermore, aspects of the biohazard barrier and system can potentially prevent transfer of biological material by individuals who unknowingly may transfer germs and microbes across multiple objects and people.

An aspect of the disclosure addresses hygiene and provide protection from direct contact with disease causing particles, microbes, and germs, such as COVID-19. An aspect of the disclosure includes a biohazard barrier and system configured to suit the differing needs and applications of users with one product without needing the traditional gloves.

### BRIEF DESCRIPTION OF THE FIGURES

The foregoing summary as well as the following detailed description, considered in conjunction with the accompanying drawings, provide a better understanding of the disclosure, in which like reference numbers refer to like elements, and wherein:

FIG. 1 shows a view of a hand skin biohazard barrier and system attached to the skin of a hand via contact points along the metacarpus, phalanxes, and the distal phalanx of the hand, also including the distal phalanges up to the fingertips and to the bottom region of the thumb according to certain aspects of the present disclosure.

FIG. 2 shows a view of a figure-tip skin hand skin biohazard barrier attached to various contact points along the distal phalanxes on the palm side of a hand according to certain aspects of the present disclosure.

FIG. 3 shows a schematic view of the hand displaying contact points along the joints and phalanges of the hand in which the biohazard barrier and system may attach according to certain aspects of the present disclosure.

FIG. 4 shows section taken along line 4-4 in FIG. 1 or FIG. 2 according to certain aspects of the present disclosure.

### DETAILED DESCRIPTION

In the following description of various aspects, a reference is made to the accompanying drawings to demonstrate various ways the disclosure may be used. It is understood that modifications or alternative methods may be used, but those modifications and alternatives do not detract from the present disclosure. Referring to the accompanying figures, a biohazard barrier and system in accordance with the present disclosure is discussed. The figures illustrate the biohazard barrier and system 100 intended for use on a left hand of a wearer. The disclosure also includes a right-hand biohazard barrier and system, such as being the mirror image of the left. In distinguishing portions of the biohazard barrier and system or the hand received by the biohazard barrier and system, reference may be made to bones within the hand and wrist. Such references are not intended to demarcate precise areas. Rather, they are intended to delineate general areas to aid in the following discussion.

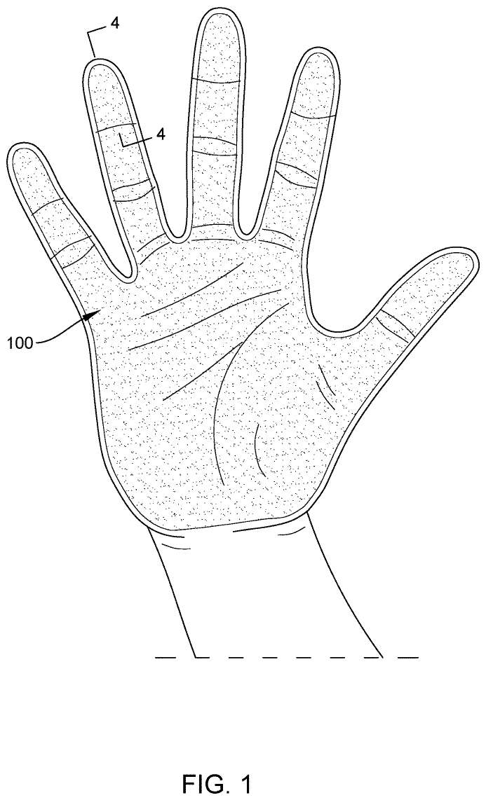

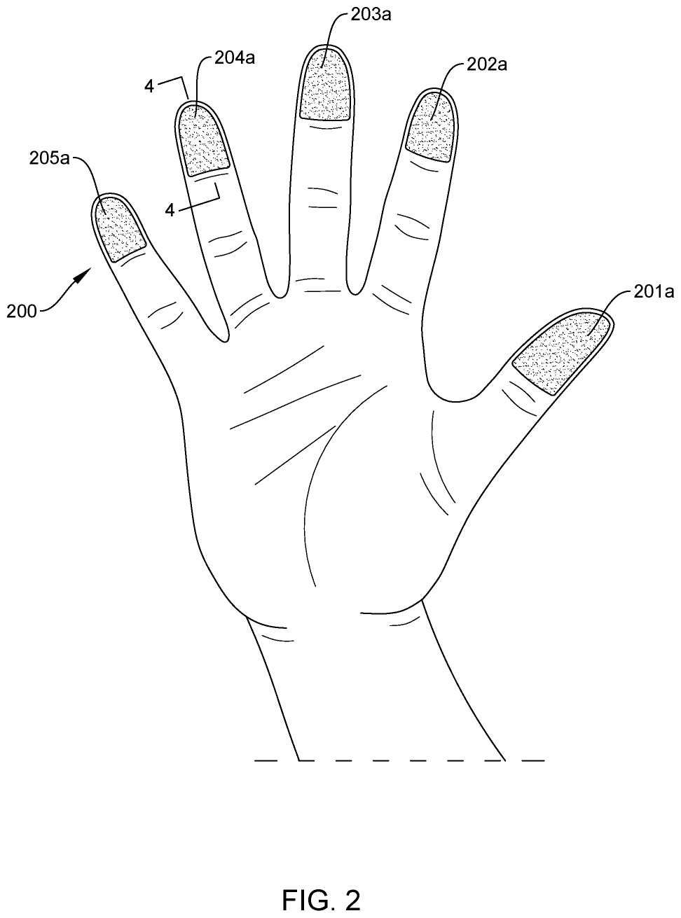

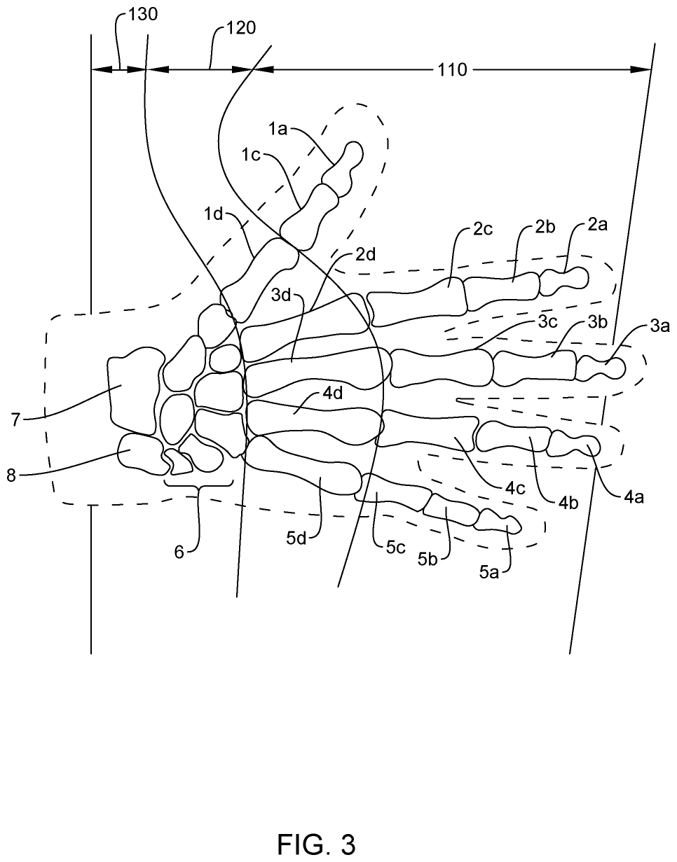

FIGS. 1 and 2 show the biohazard barrier and system 100, 200 an implementation which is an assemblage of two alternating layers 103, 105 comprising a skin-friendly releasable adhesive 103 and a non-porous material barrier 105 suitable for user to wear over the entire hand and over the fingertips, respectively. FIG. 3 shows a more detailed schematic view of the hand illustrating contact regions along the joints and phalanges of the hand in which the biohazard barrier and system 100, 200 may attach.

For a better understanding of the biohazard barrier and system 100, FIG. 3 illustrates a palmar view of barrier structure including a schematic representation with predetermined regions or portions substantially corresponding to a hand anatomy of a human body. For ease of explanation regarding the preferred implementation, the skeletal structure of a human hand includes three major divisions—a phalanx region 110, a palmar region 120, and a wrist region 130.

Some elements of biohazard barrier and system 100, depicted in FIGS. 1-4, include a phalanx region 110 and a palmar region 120 located between phalanx region 110 and the wrist 130 hand of the wearer. The phalanx region 110 includes forward phalanges 1a, 1c, 2a-c, 3a-c, 4a-c, 5a-c interconnected to metacarpal bones 1d, 2d, 3d, 4d, 5d. The phalanges and metacarpals bones are formed in five rows in which the medial side starts the first row across to the fifth row on the lateral side of the hand. The heads of the distal phalanges bones 1a, 2a, 3a, 4a, 5a have a generally bulbous structure including the hyponychium by the nail plate and finger pulp for providing a distal contact surface for gripping etc. It should be recognized that the thumb structure is the first row, which includes two phalanges 1a, 1c and a first metacarpal bone 1d. The palmar region 120 generally includes the palm formed by several interconnecting bones metacarpals 1d, 2d, 3d, 4d, and 5d. The wrist region 130 includes the carpals 6 and the joints connecting radius 7 and ulna 8 with carpals 6. One of ordinary skill in the art should recognize that hand anatomy also includes interconnecting muscles and other tissues, which are not shown for clarity. It should be recognized that these regions correspond to the typical anatomy of a human hand, which does not deviate significantly from the norm.

A wrist region 130, may be formed of a barrier material thereby generally covering carpals 6 and the joints connecting radius 7 and ulna 8 with carpals 6.

In one implementation, the biohazard barrier and system 100 comprises a flat skin hand cover/barrier that has a substantially continuous two flat layered body 103, 105 made up of two different materials acting in sequence with one another. One layer comprises of a dual sided releasable skin friendly adhesive layer 103 responsible for securing the flat skin hand cover to the skin on the palm side of the user's hand. The adhesive based layer 103 may comprise of either an elastomer, styrene-olefin-styrene block copolymers, an emollient for the elastomer, a resin promoting the adhesive capacity and optionally an oil-based extender as well as an antioxidant. Examples hereof are those shown U.S. Pat. Nos. 4,231,369, 4,367,732, and 3,339,546 which is herein incorporated by reference. The other layer 105 may comprise a slip resistant non-porous material, such as silicone, responsible for protecting the user's skin against disease causing microbes and germs when coming into contact with surfaces, objects, or individuals. In one implementation, the layer 105 may include antimicrobial additive integrated into the polymeric material such as MICROBAN.

In FIG. 1, a dual layered body of the biohazard barrier and system 100 attaches to and covers the user's hand phalanx region 110 and palmar region 120, via the skin-friendly adhesive based layer 103, along various contact points of the skin along the perimeter and the central portions of the metacarpus, phalanxes, and the distal phalanxes. Preferably, contact between the dual layered adhesive and non-porous body of the hand cover 100 is continuous throughout the majority of the surface area of the palm side of the hand and or fingertips such that there are no seams for potential exposure. As shown in FIG. 1, an exemplary implementation may include palm sizes and contact points vary across individuals. Impressions of various palm sizes from normal individuals including both male and females have been used for product improvements.

Materials used in the biohazard barrier implementation provides breathability on the dorsal side of the user's hand, easy to wear and remove, and minimal visibility.

As shown in FIG. 2, a finger-tip Biohazard barrier and system 200, for fingertip use, attaches to various contact points along the surface area of the distal phalanxes or fingertips/pads on the palm side of the hand. This implementation can be used for example, computer keyboards, touch screens, and other similar applications and can also be worn on the metacarpal or underside of the thumb. The major contact points of the biohazard barrier and system 100, 200 may be identified by observing the most routine operations of the palm and fingers of the hand. The dimensions of the biohazard barrier and system 100, 200 may be configured for sizes to deal with palms and fingertips that are widely deviant from ordinary shapes and sizes. In one implementation, the biohazard barrier and system 100, 200 may be designed for wear over lesions, scrapes, or abrasions on the skin to provide a therapeutic benefit.

In FIG. 2, a finger-tip biohazard barrier and system 200 or a full palm biohazard barrier and system 100 may fasten/secure along the major contact points and joints of the hand and its phalanges. According to the present disclosure this is achieved as product comprises least two layers of different material acting in sequence with one another. One kind of layer comprises of a skin-friendly releasable adhesive material 103 and the other layer comprises flat and pliable non-porous material 105 responsible for securing to the skin on the palm side of the hand and for coming into contact with possibly contaminated surfaces and objects. These layers of material extend substantially parallel throughout the entire thickness of the biohazard barrier 100, 200.

In the surface contact layer of 105, a two-sided, pliable non-porous material skin barrier, having on one side a flat slip resistant surface responsible for coming into contact with germ-ridden surfaces and items is provided. This layer 105 affixes to the second adhesive layer 103 configured for securing the biohazard barrier and system 100 to the skin on the palm side of the hand and fingers.

This adhesive may be selected from a group comprising an elastomer, an emollient for the elastomer, a resin promoting the adhesive capacity and optionally an oil-based extender as well as an antioxidant. Additionally, other elastomers may also be used such as natural rubber or synthetic resins configured for a skin barrier.

In one implementation, adhesive part may be adhered to the skin may be provided to promote comfort. The apparatuses 100, 200 may provide at least enhanced dexterity of the fingers, at least enhanced feel or sense of touch and low visibility.

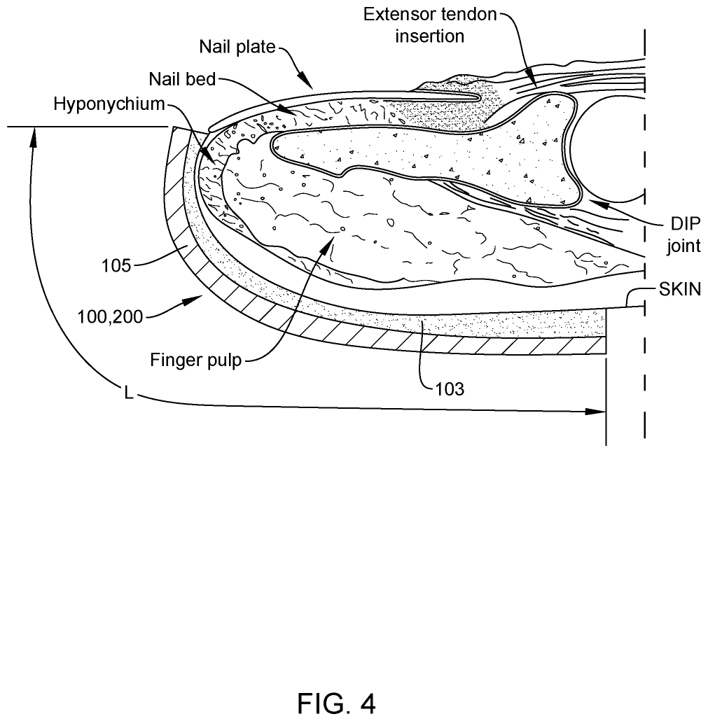

In an aspect of the disclosure, an apparatus 200 protects the fingertips of the hand of a user and includes a layer of non-porous material 105, such as silicone in conjunction with a layer of adhesive 103 that attaches to the perimeter L (See FIG. 4) and surface area of the fingertips of the hand. In exemplary implementation, the disposable non-porous hand biohazard barrier and system 200 may include fingertip pads 201a, 202a, 203a, 204a, 205a generally corresponding to the distal phalanges bones 1a, 2a, 3a, 4a, 5a, respectively.

Depending on the specific use of the disclosure may be assembled differently or available in a different shape and form serving a similar utility. A finger-tip biohazard barrier and system 200 utilized for handling something small or delicate has a different sized element from a biohazard barrier utilized for handshakes and wiping surfaces. The mode of wear may also be different for a different utility. Use of a full palm biohazard barrier and system 100 for use on the palmar side of the hand including a perimeter length L measured from the distal interphalangeal DIP joint to the nail plate distal edge or the fingernails as shown in FIG. 4.

Biohazard barrier and system 100 may be a thin layer of molded material that may provide a protective layer between the skin and surfaces to protect against bacteria, germs and dirt.

The biohazard barrier and system 100 may have adhesive layer 103 on one side that may stick to the skin. The layer 105 without adhesive may act as the protective layer between surfaces and the skin. In one implementation, the biohazard barrier and system 100, 200 may be less than ¼ inch in thickness. It may help to eliminate the transmission of dirt and germs thus, reduce the spread of germs and viruses (such as COVID-19) and minimize the transmission of such that causes illness and reactions. In an implementation, biohazard barrier and system 100, 200 leaves the dorsal side of the hand uncovered, that is that the back of the hand is uncovered. In one implementation, the whole hand biohazard barrier and system 100 shown in FIG. 1 may be molded in the shape of a whole hand with five fingers and may provide coverage from the tips of the five fingers to the lower region of the palm on the inside of the hand. The whole hand biohazard barrier and system 100 may be one molded piece. Biohazard barrier and system 100 may be easily applied and removed and discarded after each use.

In an alternative implementation as shown in FIG. 2, a finger-tip biohazard barrier and system 200 may cover the tips of the fingers, on the inside of the hand and may cover the distal phalanx (tip) to the crease between the distal phalanx and middle phalanx also known as distal interphalangeal (DIP). The finger-tip biohazard barrier and system 200 may be used in the same manner, as the whole hand biohazard barrier and system 100 and may be discarded after every use. FIG. 1 shows the image of the whole hand biohazard barrier and system 100 adhering to the inside of the whole hand. The wearer places the side with the adhesive on the inside of the hand from the tips of each finger including the palm of the hand. FIG. 2 shows a finger-tip biohazard barrier and system 200. FIG. 2 shows the basic shape of the finger-tip biohazard barrier and system 200 is the image of the finger-tip biohazard barrier and system 100 placed on and adhered to the inside of each finger-tip with barrier pads 201a, 202a, 203a, 204a, 205a.

In one method of use, after washing hands, place the biohazard barrier and system 100 on inside of a hand-palmar side. The whole hand biohazard barrier and system 100 can be used for either hand. When the person touches surfaces, instead of the dirt, germs or bacteria adhering to the persons hand, it instead is transferred to the biohazard barrier and system 100 which if discarded properly, minimizes or eliminates the transmission of contagious germs to the person. Thus, minimizes the chances of the person becoming ill with cold, flu or other viruses, such as COVD-19. If the finger-tip biohazard barrier and system 200 is used, person would wash hands and then place biohazard barrier and system 200 finger tips on all finger tips or on selected tips such as thumb or index figures. When the person touches surfaces, instead of the dirt, germs or bacteria adhering to the persons hand, it instead is transferred to the biohazard barrier and system 200 which if discarded properly, minimizes or eliminates the transmission of contagious germs to the person. Thus, minimizes the chances of the person becoming ill with cold, flu or other viruses. See FIG. 2.

Two example applications are discussed below to show some uses of the biohazard barrier and system 100, 200. One use of the barrier system 100, 200 may be on computer keyboard/screen/mouse. Another use of the barrier system 100, 200 pertains to handling or interaction between individuals and/or objects such as door handles, handshakes etc. are tasks where the skin of palms comes in direct contact with objects. These objects are usually touched by different individuals and harbor particles of different nature. The unhygienic practices of one individual can affect the other individuals. The present disclosure minimizes the spread of particles and contaminants.

In order to protect the hands from disease causing germs and microbes when coming into contact with surfaces, objects, or individuals, there are several alternatives. In circumstances, a user may need to clean or handle with care and precision something abnormally small or oddly shaped. These sort of unsanitary items or surfaces may be difficult to clean or handle with ordinary disposable gloves, either rubber or latex. This is because the excess material of the gloves that are not adequately form fitted to the hand to ensure maximum maneuverability and control. Considering the disadvantages of conventional disposable gloves, hand covers, and hand wipes, the new disposable biohazard barrier and system 100, 200 allows for increased user control, comfort, breathability and efficiency when using a protective palmar side hand cover 100, 200 to protect against disease and germs when coming into contact with surfaces, objects, or individuals.

While illustrative apparatus, systems and methods as described herein embodying various aspects of the present disclosure are shown, it may be understood by those skilled in the art, that the disclosure is not limited to these embodiments. Modifications may be made by those skilled in the art, particularly in light of the foregoing teachings. For example, each of the elements of the aforementioned embodiments may be utilized alone or in combination or sub-combination with elements of the other embodiments. It may also be appreciated and understood that modifications may be made without departing from the true spirit and scope of the present disclosure. The description is thus to be regarded as illustrative instead of restrictive on the present disclosure.

What is claimed is:

1. A skin barrier system for a human hand, comprising:
an adhesive layer that releasably secures to a palmar region and a phalanx region of a human hand; the phalanx region being defined by a first, a second, a third, a fourth, and a fifth digit, the digits being formed by distal phalanges, middle phalanges, and proximal phalanges, respectively; and
a flexible biohazard barrier layer attached to the adhesive layer, the biohazard barrier layer being configured to come in contact with surfaces and prevents containments from traveling through the biohazard barrier layer, and the adhesive layer to a skin of a human hand.

2. The skin barrier system according to claim 1, wherein the biohazard barrier layer is selected from a group consisting of a silicone and an elastomer.

3. The skin barrier system according to claim 1, wherein the adhesive layer is selected from a group consisting of an emollient for an elastomer, a styrene-olefin-styrene block copolymer, a resin promoting the adhesive capacity.

4. The skin barrier system according to claim 1, wherein a distal end of the phalanx regions is configured to extend to a least one hyponychimm to a nail distal edge.

5. A skin barrier system for a human hand, comprising:
an adhesive layer that releasably secures to area corresponding to distal phalanges of a human hand; a flexible biohazard barrier layer attached to the adhesive layer, the biohazard barrier layer being configured to come in contact with a surface and prevent containments from traveling through the biohazard barrier layer, the adhesive layer to a skin of the human hand.

6. The skin barrier system according to claim 5, wherein the biohazard barrier layer is selected from a group consisting of a silicone and an elastomer.

7. The skin barrier system according to claim 5, wherein the adhesive layer is selected from a group consisting of an emollient for an elastomer, a resin promoting the adhesive capacity, and a styrene-olefin-styrene block copolymer.

8. The skin barrier system according to claim 5, wherein a distal end of the area corresponding to the distal phalanges of a human hand is configured to extend to a least one hyponychimm to a nail distal edge to a distal interphalangeal joint.

9. The skin barrier system according to claim 8, wherein the area corresponding to the distal phalanges of a human hand corresponding to a first finger-tip area for a first distal phalange bone, a second finger-tip area for a second distal phalange bone, a third finger-tip area for a third distal phalange bone, a fourth finger-tip area for a fourth distal phalange bone, and a fifth finger-tip area for a fifth distal phalange bone.
